(19) United States
(12) Patent Application Publication
(10) Pub. No.: US 2024/0045150 A1
(43) Pub. Date: Feb. 8, 2024

(54) OPTICAL MODULE AND METHOD OF MANUFACTURING OPTICAL MODULE

(71) Applicant: SUMITOMO ELECTRIC INDUSTRIES, LTD., Osaka-shi (JP)

(72) Inventors: Kensaku SHIMADA, Osaka-shi (JP); Takeshi INOUE, Osaka-shi (JP); Taisuke NAGASAKI, Osaka-shi (JP); Toshihisa YOKOCHI, Osaka-shi (JP)

(73) Assignee: SUMITOMO ELECTRIC INDUSTRIES, LTD., Osaka-shi (JP)

(21) Appl. No.: 18/221,148

(22) Filed: Jul. 12, 2023

(30) Foreign Application Priority Data
Aug. 8, 2022 (JP) 2022-126513

(51) Int. Cl. G02B 6/36

(52) U.S. Cl. CPC G02B 6/3628

(57) ABSTRACT

An optical module includes a substrate including a main surface, an optical component including a bottom surface, and a first side surface and a second side surface each extending in a direction intersecting the bottom surface and facing each other, and an adhesion portion fixing the optical component to the substrate. The optical component is mounted on the substrate such that the bottom surface faces the main surface. In this optical module, the adhesion portion includes a plurality of first adhesion portions provided along the first side surface and a plurality of second adhesion portions provided along the second side surface.

### CROSS REFERENCE TO RELATED APPLICATIONS

This application claims the benefit of priority from Japanese Patent Application No. 2022-126513, filed on Aug. 8, 2022, the entire contents of which are incorporated herein by reference.

### TECHNICAL FIELD

The present disclosure relates to an optical module and a method of manufacturing an optical module.

### BACKGROUND

JP2019-082508A discloses an optical module including a substrate to which photoelectric conversion elements are attached and a lens component disposed on the substrate.

### SUMMARY

In one aspect, the present disclosure provides an optical module that includes a substrate including a main surface, an optical component including a bottom surface, and a first side surface and a second side surface each extending in a direction intersecting the bottom surface and facing each other, the optical component being mounted on the substrate such that the bottom surface faces the main surface, and an adhesion portion fixing the optical component to the substrate. In this optical module, the adhesion portion includes a plurality of first adhesion portions provided along the first side surface and a plurality of second adhesion portions provided along the second side surface

### BRIEF DESCRIPTION OF THE DRAWINGS

FIG. 1 is a perspective view of an optical module according to one embodiment.

FIG. 2 is an exploded perspective view of the optical module shown in FIG. 1.

FIG. 3 is a top view of a substrate on which a second lens module of the optical module is loaded.

FIG. 4 is a cross-sectional view showing the shape of a first uneven portion of the substrate.

FIGS. 5A to 5E illustrate cross-sectional views each showing an example of a shape of a second uneven portion of the second lens module, wherein FIG. 5A is a view showing an example of the second uneven portion having a rectangular shape, FIG. 5B is a view showing an example of the second uneven portion having a corrugated shape, FIG. 5C is a view showing an example of the second uneven portion having a trapezoidal shape, FIG. 5D is a view showing an example of the second uneven portion including holes each having a circular cross section, and FIG. 5E is a view showing an example of the second uneven portion including holes each having an inverted trapezoidal shape inverse to the second uneven portion of FIG. 5C.

FIG. 6 is a top view of the substrate on which a second lens module according to a first modification is loaded.

FIG. 7 is a side view of a second lens module according to a second modification.

### DETAILED DESCRIPTION

### Problems to be Solved By the Present Disclosure

In the optical module described in JP2019-082508A, an optical component such as a lens component is mounted on a substrate with an adhesive or the like. In this case, one point along each side surface of the optical component is often fixed by an adhesive. Miniaturization is advanced in such an optical module, and it is becoming insufficient to fix the lens component on the substrate by the adhesive at one point for each side surface, and thus the optical component may be detached from the substrate when the optical module is connected to another optical module or the like.

### Effects of the Present Disclosure

According to the present disclosure, an optical component is reliably fixed to a substrate in an optical module.

### Description of Embodiments of Present Disclosure

First, the contents of embodiments of the present disclosure will be listed and explained.

[1] An optical module according to an embodiment of the present disclosure includes a substrate including a main surface, an optical component including a bottom surface, and a first side surface and a second side surface each extending in a direction intersecting the bottom surface and facing each other, the optical component being mounted on the substrate such that the bottom surface faces the main surface, and an adhesion portion fixing the optical component to the substrate. In this optical module, the adhesion portion includes a plurality of first adhesion portions provided along the first side surface and a plurality of second adhesion portions provided along the second side surface.

In this optical module of [1], the first adhesion portions are provided at a plurality of locations along the first side surface, and the second adhesion portions are provided at a plurality of locations along the second side surface. In this embodiment, the total area in which the optical component and the substrate are adhered to each other can be increased by the first adhesion portions and the second adhesion portions. According to this optical module, the optical component can be more firmly adhered to the substrate, and thus the optical component can be reliably fixed to the substrate. In addition, this optical module is provided with a plurality of first adhesion portions and a plurality of second adhesion portions, and thus a region where the optical component is adhered to the substrate is configured to be divided into a large number of regions. As a result, stress acting on the optical component during curing of the adhesion portion is dispersed. According to this optical module, deformation of the optical component can be suppressed.

[2] In the optical module according to [1] above, the plurality of first adhesion portions and the plurality of second adhesion portions may be disposed to be line-symmetric with respect to a center line. The center line passes through a center of the optical component in a direction in which the first side surface and the second side surface face each other and extends in a direction parallel to an optical axis of the optical component. In this embodiment, the optical component can be more stably fixed to the substrate by the first adhesion portions and the second adhesion portions. Therefore, the optical component can be more reliably fixed to the substrate in this optical module.

[3] In the optical module according to [1] or [2] above, the plurality of first adhesion portions may be provided between the main surface and at least one of a portion of the first side surface close to the bottom surface and a portion of the bottom surface close to the first side surface. The plurality of second adhesion portions may be provided between the main surface and at least one of a portion of the second side surface close to the bottom surface and a portion of the bottom surface close to the second side surface. In this embodiment, the adhesion portions are easily provided along the first side surface and the second side surface even in a state in which the optical component is disposed on the substrate and the position of the optical component is determined. Therefore, deformation of the optical component can be easily suppressed in this optical module while the adhesive force between the substrate and the optical component is easily improved.

[4] In the optical module according to any one of [1] to [3] above, the main surface of the substrate may be provided with a first uneven portion in at least a part of a portion where the main surface is in contact with the adhesion portion. In this embodiment, the adhesion portion flows into depressions of the first uneven portion, and an adhesion area where the adhesion portion and the substrate are in contact with each other can be increased. Therefore, the optical component can be more reliably fixed to the substrate in this optical module.

[5] In the optical module according to [4] above, an arithmetical mean roughness Ra of the first uneven portion may be equal to or greater than 0.4 μm and equal to or less than 0.7 μm. When the arithmetic mean roughness Ra of the first uneven portion is 0.4 μm or more, the adhesion portion easily flows into depressions of the first uneven portion, and the adhesion area in which the adhesion portion and the substrate are in contact with each other can be more reliably increased. In addition , when the arithmetic mean roughness Ra of the first uneven portion is 0.7 μm or less, it is possible to prevent the optical axis of the optical component from being deviated when the optical component is disposed on the main surface of the substrate. Therefore, it is possible to reliably fix the optical component to the substrate in this optical module while suppressing deviation of the optical axis or the like. The term “arithmetic mean roughness Ra” as used herein means a value measured in accordance with JIS B0601-2001.

[6] In the optical module according to any one of [1] to [5] above, the bottom surface of the optical component may be provided with a second uneven portion in at least a part of a portion where the bottom surface is in contact with the adhesion portion. In this embodiment, the adhesion portion flows into depressions of the second uneven portion, and an adhesion area where the adhesion portion and the optical component are in contact with each other can be increased. Therefore, the optical component can be more reliably fixed to the substrate in this optical module.

[7] In the optical module according to any one of [1] to [6] above, the first side surface and the second side surface of the optical component each may be provided with a third uneven portion in at least a part of a portion where the first side surface or the second side surface is in contact with the adhesion portion. In this embodiment, the adhesion portion flows into depressions of the third uneven portion, and an adhesion area where the adhesion portion and the optical component are in contact with each other can be increased. Therefore, the optical component can be more reliably fixed to the substrate in this optical module.

[8] In the optical module according to any one of [1] to [7] above, the first side surface and the second side surface may be inclined such that a distance between the first side surface and the second side surface decreases away from the bottom surface of the optical component. The adhesion portion may be provided on the inclined first side surface and the inclined second side surface. In this embodiment, it is possible to increase an adhesion area where the first adhesion portion and the first side surface are in contact with each other and an adhesion area where the second adhesion portion and the second side surface are in contact with each other. Therefore, the optical component can be more reliably fixed to the substrate in this optical module.

[9] A method of manufacturing an optical module according to an embodiment of the present disclosure includes preparing a substrate including a main surface, preparing an optical component including a bottom surface, and a first side surface and a second side surface each extending in a direction intersecting the bottom surface and facing each other, disposing the optical component on the main surface of the substrate such that the bottom surface faces the main surface, and fixing the optical component to the substrate by applying a first adhesive to a plurality of portions along the first side surface, by applying a second adhesive to a plurality of portions along the second side surface, and by curing the first adhesive and the second adhesive. According to this manufacturing method, it is possible to increase an adhesion area where the adhesive and the optical component are in contact with each other and an adhesion area where the adhesive and the substrate are in contact with each other. In addition, since the number of portions to which the adhesive is applied is increased, the stress acting on the optical component when the adhesive is cured is dispersed. Therefore, deformation of the optical component can be suppressed. As described above, according to the method of manufacturing an optical module, it is possible to manufacture an optical module in which deformation of an optical component is suppressed while the optical component is reliably fixed to the substrate.

[10] In the method of manufacturing an optical module according to [9] above, in the fixing, the first adhesive may be applied between the main surface and at least one of a portion of the first side surface close to the bottom surface and a portion of the bottom surface close to the first side surface, the second adhesive may be applied between the main surface and at least one of a portion of the second side surface close to the bottom surface and a portion of the bottom surface close to the second side surface, and the first adhesive and the second adhesive may be applied to be line-symmetric with respect to a center line. The center line passes through a center of the optical component in a direction in which the first side surface and the second side surface face each other and extends in a direction parallel to an optical axis of the optical component. In this embodiment, the optical component can be more stably fixed to the substrate by the first adhesive and the second adhesive. According to the method of manufacturing an optical module, the optical component can be more reliably fixed to the substrate.

### Details of Embodiments of Present Disclosure

Specific examples of an optical module and a method of manufacturing an optical module according to the present disclosure will be described below with reference to the drawings. The present invention is not limited to these examples, but is defined by the scope of the claims, and is intended to include all modifications within the meaning and scope equivalent to the scope of the claims. In the description of the drawings, the same elements are denoted by the same reference numerals, and redundant description is omitted.

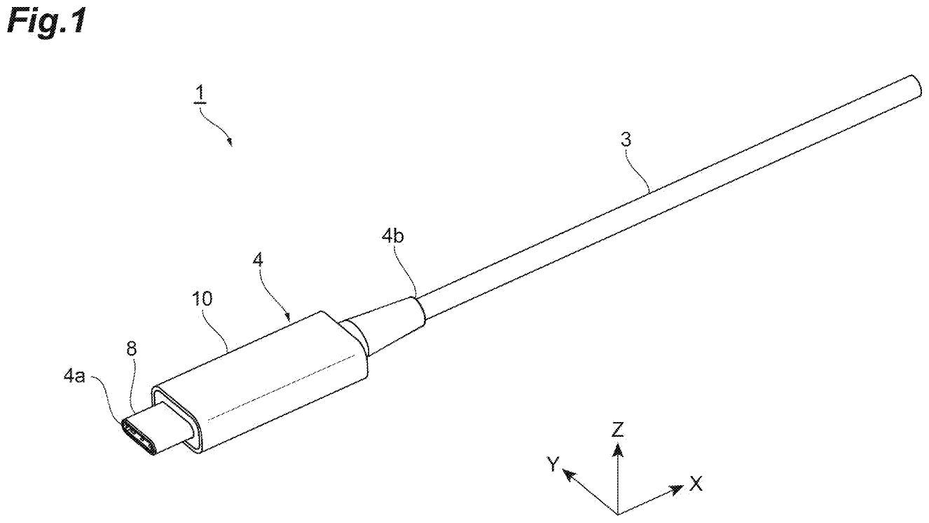

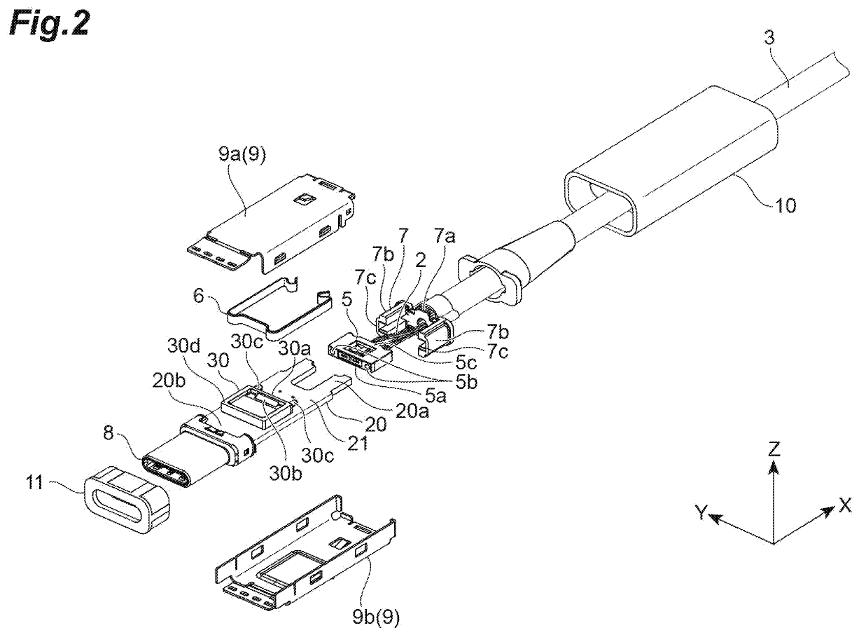

FIG. 1 is a perspective view of an optical module according to one embodiment. As shown in FIG. 1, an optical module 1 includes a cable 3 including a plurality of optical fibers 2 (see FIG. 2), and a connector module 4 attached to a tip of cable 3. Connector module 4 is a connector extending along a longitudinal direction X (also referred to as an X direction), and has a front end 4a and a rear end 4b in the X direction. Rear end 4b is located on the opposite side of front end 4a in the X direction. Connector module 4 has an electrical connector at front end 4a, cable 3 is connected to rear end 4b, and optical fibers 2 of cable 3 are inserted into connector module 4 from rear end 4b. In the following description, a width direction of connector module 4 is referred to as a Y direction, and a height direction of connector module 4 is referred to as a Z direction. The Z direction is orthogonal to the X direction and the Y direction.

FIG. 2 is an exploded perspective view of optical module 1 shown in FIG. 1. As shown in FIGS. 1 and 2, connector module 4 of optical module 1 includes a first lens module 5, a fitting spring 6, a metal member 7, a plug 8, a metal housing 9, a resin housing 10, a front cap 11, a substrate 20, and a second lens module 30.

First lens module 5 is an optical component that holds a plurality of optical fibers 2 constituting cable 3 and is connectable to second lens module 30 along the X direction. First lens module 5 is a resin member having a substantially rectangular parallelepiped shape. First lens module 5 has a front end surface 5a perpendicular to the X direction and a pair of guide holes 5b. First lens module 5 is configured such that the tip of each optical fiber 2 of cable 3 inserted from the rear end surface (not shown) of first lens module 5 is exposed from front end surface 5a.

Guide holes 5b are holes for positioning provided so as to sandwich the plurality of optical fibers 2 exposed on front end surface 5a, and each extends in first lens module 5 along the X direction. When first lens module 5 is connected to second lens module 30, a pair of guide pins 30c of second lens module 30 are inserted into the pair of guide holes 5b, thereby positioning first lens module 5 with respect to second lens module 30.

Fitting spring 6 is a member that maintains a connection state between first lens module 5 and second lens module 30 when first lens module 5 is connected to second lens module 30. Fitting spring 6 is configured to hold a rear end 5c of first lens module 5 and a rear end 30d of second lens module 30 and press them against each other to maintain the connection state.

Metal member 7 is connected to cable 3 and holds substrate 20. Metal member 7 includes a flat plate portion 7a extending in a direction perpendicular to the X direction and a pair of support portions 7b extending from flat plate portion 7a in the X direction. An opening is formed in flat plate portion 7a, and optical fibers 2 are inserted through the opening. A recess 7c is formed in each of the pair of support portions 7b. Metal member 7 holds substrate 20 by fitting a rear end 20a of substrate 20 into recess 7c.

Plug 8 covers and protects a plurality of terminals (not shown) provided on a front end 20b of substrate 20, and is connected to a connector provided on another substrate (not shown). Plug 8 includes an insertion port which is located between rear end 4b and front end 4a in the X direction. Plug 8 is attached to substrate 20 by inserting front end of substrate 20 from the insertion port of plug 8.

Metal housing 9 has a housing upper portion 9a and a housing lower portion 9b. Substrate 20 and second lens module 30 are disposed and protected inside metal housing 9 constituted by housing upper portion 9a and housing lower portion 9b.

Front cap 11 is fitted to the opening on the front side of resin housing 10 to close the opening. Front cap 11 has a through hole corresponding to plug 8. Therefore, by inserting plug 8 into the through hole of front cap 11, front cap 11 can be fitted to the opening on the front side of resin housing 10.

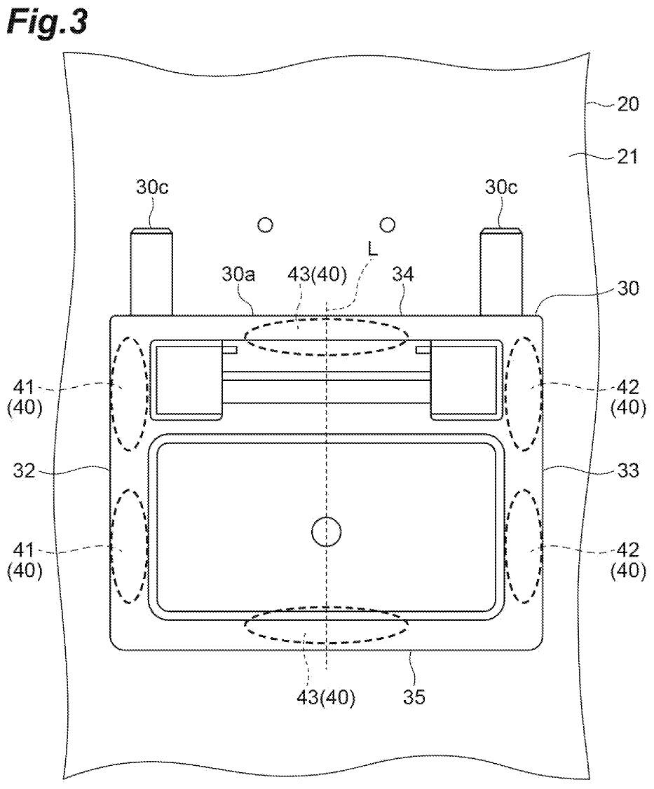

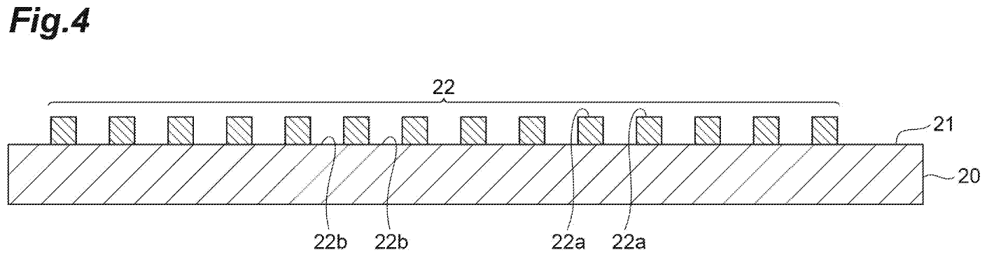

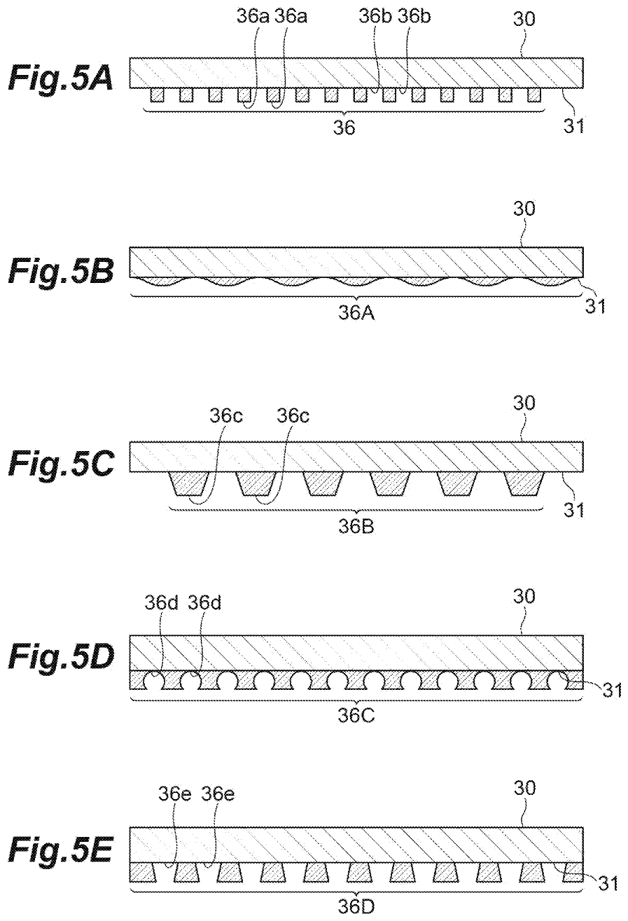

Next, substrate 20 and second lens module 30 in optical module 1 will be described in detail with reference to FIGS. 2, 3, 4 and 5A to 5E. FIG. 3 is a top view of substrate 20 on which second lens module 30 of optical module 1 is loaded when viewed from above. FIG. 4 is a cross-sectional view showing a shape of a first uneven portion 22 of substrate 20. FIGS. 5A to 5E illustrate cross-sectional views each showing an example of a shape of a second uneven portion 36 of second lens module 30, wherein FIG. 5A is a view showing an example of second uneven portion 36 having a rectangular shape, FIG. 5B is a view showing an example of a second uneven portion 36A (modification of second uneven portion 36) having a corrugated shape, FIG. 5C is a view showing an example of a second uneven portion 36B (modification of second uneven portion 36) having a trapezoidal shape, FIG. 5D is a view showing an example of a second uneven portion 36C (modification of second uneven portion 36) including holes each having a circular cross section, and FIG. 5E is a view showing an example of a second uneven portion 36D (modification of second uneven portion 36) including holes each having an inverted trapezoidal shape inverse to second uneven portion 36B. As shown in FIG. 3, second lens module 30 is mounted on substrate 20 by the plurality of adhesion portions 40 in optical module 1.

As shown in FIG. 3, substrate 20 is a member in which a metal wiring pattern (not shown) is formed on a surface of a dielectric substrate having a substantially rectangular flat plate shape. Substrate 20 is held by metal member 7. Second lens module 30 is fixed on a main surface 21 of substrate 20 by the plurality of adhesion portions 40 which will be described later.

As shown in FIG. 4, main surface 21 of substrate 20 may be provided with first uneven portion 22 that includes protrusions 22a each having a rectangular cross-section in at least a part of a portion where main surface 21 is in contact with adhesion portion 40. The arithmetic mean roughness Ra of first uneven portion 22 is, for example, 0.4 μm or more. The arithmetic mean roughness Ra of first uneven portion 22 may be, for example, 0.7 μm or less. As a portion of adhesion portion 40 flows into depressions 22b of first uneven portion 22, the contact area between main surface 21 of substrate 20 and adhesion portion 40 increases. The cross-sectional shape of each protrusion 22a of first uneven portion 22 is not limited to a rectangular shape, and may be another shape such as a corrugated shape (a wave shape) or a trapezoidal shape. In FIG. 4, the uneven shape is shown in an emphasized manner.

Second lens module 30 is an optical component configured to be optically coupled to each tip of the plurality of optical fibers 2 of cable 3 held by first lens module 5. As shown in FIGS. 3 and FIGS. 5A to 5E, second lens module 30 has a bottom surface 31, a first side surface 32, a second side surface 33, a front end surface 34, and a rear end surface 35. First side surface 32 and second side surface 33 each extend in a direction perpendicular to bottom surface 31, and face each other. Front end surface 34 and rear end surface 35 each extend in a direction perpendicular to bottom surface 31, face each other, and are perpendicular to first side surface 32 and second side surface 33. Second lens module 30 is mounted on substrate 20 such that bottom surface 31 faces main surface 21 of substrate 20.

As shown in FIG. 5A, bottom surface 31 of second lens module 30 may be provided with second uneven portion 36 that includes protrusions 36a each having a rectangular cross section in at least a part of a portion where bottom surface 31 is in contact with adhesion portion 40. The height of the protrusion 36a of second uneven portion 36 from bottom surface 31 (the depth of the depressions 36b) may be, for example, from 10 μm to 50 μm. As a portion of adhesion portion 40 flows into the depressions 36b of second uneven portion 36, the contact area between bottom surface 31 of second lens module 30 and adhesion portion 40 increases. The shape of second uneven portion 36 may be another shape, and may be, for example, a shape of modification (one of second uneven portion 36A and second uneven portion 36B) shown in FIG. 5B and FIG. 5C, respectively. Second uneven portion 36A has a corrugated shape (a wave shape), and second uneven portion 36B includes protrusions 36c each having a trapezoidal shape. Accordingly, like second uneven portion 36, the contact area between bottom surface 31 of second lens module 30 and adhesion portion 40 is increased in the modification of FIGS. 5B and 5C.

Further, the shape of second uneven portion 36 may be a shape of modification (one of second uneven portion 36C and second uneven portion 36D) shown in FIG. 5D and FIG. 5E, respectively. Second uneven portion 36C includes depressions 36d each having a circular shape, and second uneven portion 36D includes depressions 36e each having an inversed trapezoidal shape inverse to protrusion 36c of second uneven portion 36B. Accordingly, the contact area between bottom surface 31 of second lens module 30 and adhesion portion 40 increases in the modification of FIGS. 5D and 5E and further adhesion portion 40 that has entered the depressions 36d, 36e of second uneven portion 36C or second uneven portion 36D is less likely to come off from the depressions due to the anchor effect. Thus, second lens module 30 of FIG. 5D or FIG. 5E can be more reliably fixed to substrate 20.

As shown in FIG. 2, second lens module 30 further includes a plurality of light incidence/emission portions 30a, a mirror surface 30b, and a pair of guide pins 30c. Each of the plurality of light incidence/emission portions 30a has an optical axis extending in the X direction on a plane parallel to main surface 21 of substrate 20 (see also FIGS. 5A to 5E). The plurality of light incidence/emission portions 30a are disposed along the Y direction orthogonal to the X direction on a plane parallel to main surface 21. The optical signal emitted from each of the plurality of optical fibers 2 is incident into second lens module 30 through a corresponding light incidence/emission portion 30a. When light emitting devices (not shown) are provided on substrate 20, an optical signal emitted from each light emitting device is emitted from each of the plurality of light incidence/emission portions 30a via mirror surface 30b, and is incident on each tip of optical fibers 2 held by first lens module 5.

Mirror surface 30b is a reflection surface forming an angle of approximately 45 degrees with respect to the X direction and the Z direction. Mirror surface 30b is an optical structure for reflecting the light emitted from optical fiber 2 held by first lens module 5 by 90° toward light-receiving device (not shown) provided on substrate 20. When light emitting devices (not shown) are provided on substrate 20, mirror surface 30b reflects an optical signal propagating in a vertical direction from each light emitting device by 90° toward each optical fiber 2. By inserting the pair of guide pins 30c into the pair of guide holes 5b of first lens module 5, alignment in optical coupling between first lens module 5 and second lens module 30 is performed.

Referring back to FIG. 3, adhesion portions 40 will be described. Each adhesion portion 40 is a member for fixing second lens module 30 to substrate 20. Adhesion portion 40 is, for example, a thermosetting adhesive. After adhesion portion 40 is injected into a predetermined position, adhesion portion 40 is cured by applying heat to fix predetermined members to each other by adhesion. The plurality of adhesion portions 40 includes two first adhesion portions 41, two second adhesion portions 42, and two third adhesion portions 43. First adhesion portions 41 are provided at two locations along first side surface 32 between main surface 21 of substrate 20 and a portion of bottom surface 31 of second lens module 30 close to first side surface 32. Second adhesion portions 42 are provided at two locations along second side surface 33 between main surface 21 of substrate 20 and a portion of bottom surface 31 of second lens module 30 close to second side surface 33. Third adhesion portions 43 are provided between main surface 21 of substrate 20 and bottom surface 31 of second lens module 30 and along each side surface of front end surface 34 and rear end surface 35. That is, first adhesion portions 41, second adhesion portions 42, and third adhesion portions 43 are in contact with main surface 21 of substrate 20 and bottom surface 31 of second lens module 30 to fix them.

First adhesion portions 41 and second adhesion portions 42 are disposed to be line-symmetric with respect to a center line L. The center line L passes through a center of second lens module 30 in a direction in which first side surface 32 and second side surface 33 face each other and extends in a direction parallel to an optical axis of second lens module 30. Accordingly, second lens module 30 is stably fixed to main surface 21 of substrate 20. One of the two first adhesion portions 41 may be in contact with the other first adhesion portion 41. In this case, when viewed from a direction perpendicular to first side surface 32, two first adhesion portions 41 may have two mountain-like shapes, and the bottom portions of the two mountain-like shapes may be in contact with each other, for example. The same applies to two second adhesion portions 42.

Next, a method of manufacturing optical module 1 will be described with reference to FIG. 3. In the method of manufacturing optical module 1, first, substrate 20 having main surface 21 is prepared. Second lens module 30 having bottom surface 31, first side surface 32, second side surface 33, front end surface 34, and rear end surface 35 is also prepared.

Subsequently, second lens module 30 is disposed on main surface 21 of substrate 20 such that bottom surface 31 faces main surface 21. At this time, the disposition and posture of second lens module 30 are adjusted such that the optical axis of second lens module 30 is aligned with the optical axis of another optical component (first lens module 5) to be connected to second lens module 30 in a process to be described later.

Subsequently, when the adjustment of second lens module 30 is completed, the first adhesive is applied to a plurality of portions (corresponding to first adhesion portions 41) along first side surface 32, and the second adhesive is applied to a plurality of portions (corresponding to second adhesion portions 42) along second side surface 33. Each of the first adhesive and the second adhesive is, for example, a thermosetting epoxy-based adhesive, and is applied to a predetermined portion using a dispenser or the like. The first adhesive and the second adhesive are cured by being heated in a process to be described later to become first adhesion portions 41 and second adhesion portions 42, respectively, and fix second lens module 30 to substrate 20.

The first adhesive may be applied between main surface 21 and a portion of first side surface 32 close to bottom surface 31, and may be applied between main surface 21 and a portion of bottom surface 31 close to first side surface 32. That is, the first adhesive may be applied between main surface 21 and at least one of a portion of first side surface 32 close to bottom surface 31 and a portion of bottom surface 31 close to first side surface 32. The second adhesive may be applied between main surface 21 and a portion of second side surface 33 close to bottom surface 31, and may be applied between main surface 21 and a portion of bottom surface 31 close to second side surface 33. That is, the second adhesive may be applied between main surface 21 and at least one of a portion of second side surface 33 close to bottom surface 31 and a portion of bottom surface 31 close to second side surface 33. In the example shown in FIG. 3, the first adhesive is applied between main surface 21 and a portion of bottom surface 31 close to first side surface 32, and the second adhesive is applied between main surface 21 and a portion of bottom surface 31 close to second side surface 33. When the adhesive is applied as described above, it is preferable that the first adhesive and the second adhesive are applied to be line-symmetric with respect to center line L of second lens module 30. As shown in FIG. 3, another adhesive may be applied between main surface 21 and a portion of bottom surface 31 close to front end surface 34, and another adhesive may be applied between main surface 21 and a portion of bottom surface 31 close to rear end surface 35. When the adhesive is applied along front end surface 34, the adhesive is applied so that the adhesive does not spread to the plurality of light incidence/emission portions 30a or the pair of guide pins 30c.

Subsequently, when the application of the adhesive such as the first adhesive and the second adhesive is completed, the adhesive such as the first adhesive and the second adhesive is cured. At the time of curing, in the case where the first adhesive, the second adhesive, and the like are thermosetting adhesives, the adhesives such as the first adhesive and the second adhesive can be cured by applying heat. The cured adhesives such as the first adhesive and the second adhesive become first adhesion portions 41, second adhesion portions 42, and third adhesion portions 43, respectively, to fix second lens module 30 to substrate 20.

Subsequently, when the attachment of second lens module 30 to substrate 20 is completed, as shown in FIG. 2, first lens module 5 holding the tip portions of the plurality of optical fibers 2 constituting cable 3 is connected to second lens module 30 fixed to substrate 20. Thereafter, fitting spring 6 is set so that the connected first lens module 5 and second lens module 30 are fitted into fitting spring 6, thereby maintaining the connection state between first lens module 5 and second lens module 30. At this time, second lens module 30 is firmly fixed to substrate 20 by the adhesion portions 41 to 43 in which the adhesives applied to a plurality of portions are cured. Thus, even if the fitting force of fitting spring 6 is strong or an external force is applied from first lens module 5, second lens module 30 is not easily separated from substrate 20.

Subsequently, first lens module 5, second lens module 30, substrate 20, and the like are interposed between housing upper portion 9a and housing lower portion 9b, and substrate 20 and the like are disposed inside metal housing 9. Then, metal housing 9 is disposed inside resin housing 10, and front cap 11 is fitted into the opening of resin housing 10. By the manufacturing method described above, optical module 1 described above is obtained.

### Modification

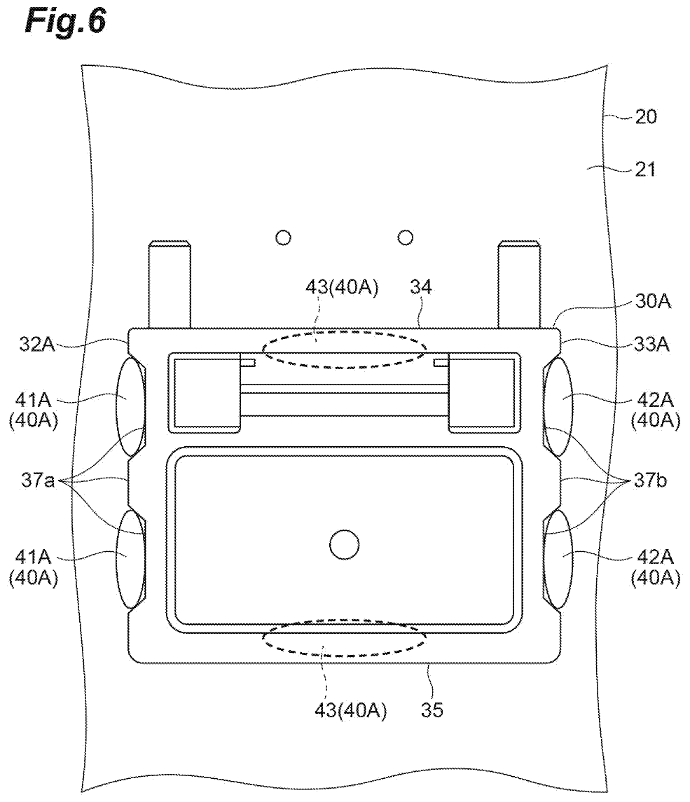

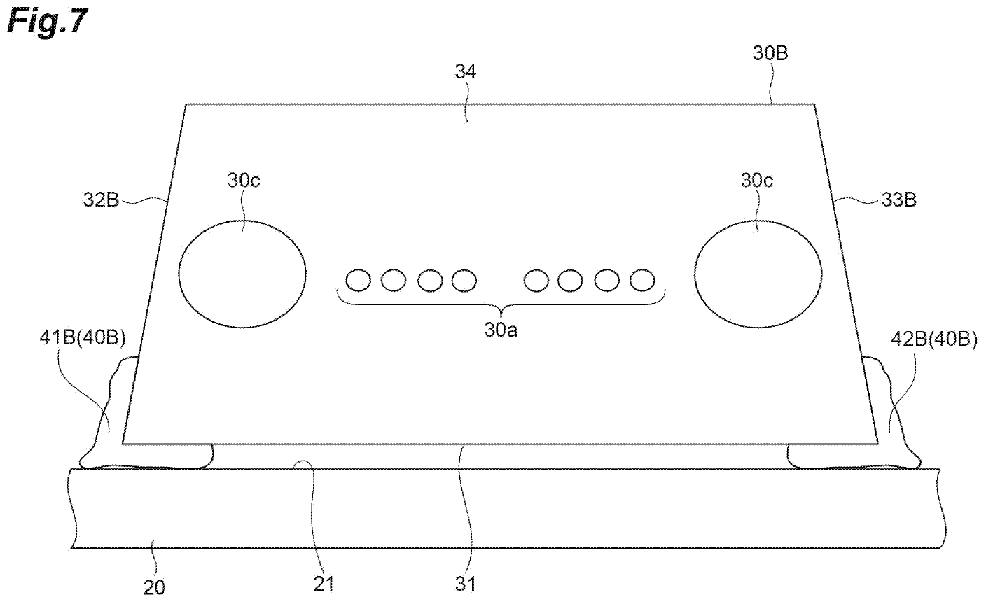

Modification of second lens module 30 and adhesion portions 40 (second lens modules 30A and 30B; and adhesion portions 40A and 40B) will now be described with reference to FIGS. 6 and 7. FIG. 6 is a top view of substrate 20 viewed from above on which second lens module 30A according to a first modification is loaded. FIG. 7 is a side view of second lens module 30B according to a second modification. Hereinafter, differences from second lens module 30 and adhesion portions 40 of optical module 1 according to the embodiment will be mainly described, and other descriptions may be omitted.

First, second lens module 30A and adhesion portions 40A according to the first modification will be described with reference to FIG. 6. Second lens module 30A has a first side surface 32A and a second side surface 33A as shown in FIG. 6. First side surface 32A and second side surface 33A are provided with a third uneven portion 37a and a third uneven portion 37b at portions where first side surface 32A and second side surface 33A are in contact with adhesion portions 40A. Third uneven portions 37a is provided on first side surface 32A, and third uneven portion 37b is provided on second side surface 33A.

Adhesion portions 40A include two first adhesion portions 41A and two second adhesion portions 42A. One first adhesion portion 41A of the two first adhesion portions 41A is provided at a depression of third uneven portion 37a close to front end surface 34, and between main surface 21 and a portion of bottom surface 31 close to first side surface 32A. Another first adhesion portion 41A is provided at another depression of third uneven portion 37a close to rear end surface 35, and between main surface 21 and a portion of bottom surface 31 close to first side surface 32A. Accordingly, the contact area between first adhesion portions 41A and first side surface 32A increases.

One second adhesion portion 42A of the two second adhesion portions 42A is provided at a depression of third uneven portion 37b close to front end surface 34, and between main surface 21 and the portion of bottom surface 31 close to second side surface 33A. Another second adhesion portion 42A is provided at another depression of third uneven portion 37b close to rear end surface 35, and between main surface 21 and a portion of bottom surface 31 close to second side surface 33A. Accordingly, the contact area between second adhesion portions 42A and second side surface 33A increases.

Next, second lens module 30B and adhesion portions 40B according to the second modification will be described with reference to FIG. 7. Second lens module 30B has a first side surface 32B and a second side surface 33B as shown in FIG. 7. First side surface 32B and second side surface 33B are inclined such that a distance between first side surface 32B and second side surface 33B decreases gradually away from bottom surface 31. That is, front end surface 34 of second lens module (a cross-section of second lens module 30B parallel to front end surface 34) has a trapezoidal shape. An angle formed by first side surface 32B and bottom surface 31 and an angle formed by second side surface 33B and bottom surface 31 are, for example, from 70 degrees to 90 degrees.

Similar to adhesion portions 40 and 40A, adhesion portions 40B includes two first adhesion portions 41B and two second adhesion portions 42B. One first adhesion portion 41B of the two first adhesion portions 41B is provided between main surface 21 and a portion of first side surface 32B close to bottom surface 31, and between main surface 21 and a portion of bottom surface 31 close to first side surface 32B, and is close to front end surface 34. Another first adhesion portion 41B (not shown) is provided between main surface 21 and a portion of first side surface 32B close to bottom surface 31, and between main surface 21 and a portion of bottom surface 31 close to first side surface 32B, and is close to rear end surface 35.

One second adhesion portion 42B of the two second adhesion portions 42B is provided between main surface 21 and a portion of second side surface 33B close to bottom surface 31, and between main surface 21 and portion of bottom surface 31 close to second side surface 33B, and is close to front end surface 34. Other second adhesion portion 42B (not shown) is provided between main surface 21 and a portion of second side surface 33B close to bottom surface 31, and between main surface 21 and a portion of bottom surface 31 close to second side surface 33B, and is close to rear end surface 35. Since first side surface 32B and second side surface 33B are inclined surfaces as described above, it is easy to provide first adhesion portions 41B and second adhesion portions 42B on each side surface. Thus, the contact area between first adhesion portions 41B and first side surface 32B and the contact area between second adhesion portions 42B and second side surface 33B can be increased.

As described above, in optical module 1 according to the embodiments of the present disclosure, first adhesion portions 41, 41A, and 41B are provided at a plurality of locations along first side surfaces 32, 32A, and 32B, and second adhesion portions 42, 42A, and 42B are provided at a plurality of locations along second side surfaces 33, 33A, and 33B. Accordingly, a total area in which substrate 20 and second lens module 30, 30A, or 30B are adhered to each other by first adhesion portion 41, 41A, or 41B and second adhesion portion 42, 42A, or 42B can be increased. According to optical module 1, second lens modules 30, and 30B can be more firmly adhered to substrate 20, and second lens modules 30, 30A, and 30B can be reliably fixed to substrate 20. Further, in optical module 1, a plurality of first adhesion portions 41, 41A, and 41B and a plurality of second adhesion portions 42, 42A, and 42B are provided, and a region where second lens modules 30, 30A, and 30B are adhered to substrate 20 is divided into a plurality of regions. Accordingly, when adhesion portions 40, 40A, and 40B are cured, stress acting on each of second lens modules 30, 30A, and 30B is dispersed. According to optical module 1, deformation of each of second lens modules 30, 30A, and 30B can be suppressed.

In optical module 1, the plurality of first adhesion portions 41, 41A, 41B and the plurality of second adhesion portions 42, 42A, 42B are disposed to be line-symmetric with respect to center line L. Center line L passes through the center of second lens modules 30, 30A, 30B in a direction in which first side surfaces 32, 32A, 32B and corresponding second side surfaces 33, 33A, 33B face each other, and extends in a direction parallel to the optical axis of second lens modules 30, 30A, 30B. Accordingly, second lens modules 30, 30A, and 30B may be more stably fixed to substrate 20 by first adhesion portions 41, 41A, and 41B and second adhesion portions 42, 42A, and 42B. Therefore, in optical module 1, second lens module 30, 30A, or 30B can be more reliably fixed to substrate 20.

In optical module 1, the plurality of first adhesion portions 41, 41A, and 41B are provided between main surface 21 and respective portions of bottom surface 31 close to first side surfaces 32, 32A, and 32B, and the plurality of second adhesion portions 42, 42A, and 42B are provided between main surface 21 and respective portions of bottom surface 31 close to second side surfaces 33, 33A, and 33B. Accordingly, even in a state where second lens modules 30, 30A, 30B are disposed on substrate 20 and second lens modules 30, 30A, 30B are positioned, adhesion portions 40, 40A, 40B can be easily provided along first side surfaces 32, 32A, 32B and second side surfaces 33, 33A, 33B. Therefore, in optical module 1, it is possible to easily improve the adhesive force between substrate 20 and second lens module 30, 30A, or 30B and to easily suppress the deformation of second lens module 30, 30A, or 30B.

In optical module 1, main surface 21 of substrate 20 is provided with first uneven portion 22 at least a part of a portion where main surface 21 is in contact with adhesion portion 40. As a result, adhesion portion 40 flows into the depressions 22b of first uneven portion 22, and an adhesion area where adhesion portion 40 and substrate 20 contact each other can be increased. Therefore, in optical module 1, second lens module 30 can be more reliably fixed to substrate 20.

In optical module 1, the arithmetic mean roughness Ra of first uneven portion 22 is equal to or greater than 0.4 μm and equal to or less thna 0.7 μm. When the arithmetic mean roughness Ra of first uneven portion 22 is 0.4 μm or more, adhesion portion 40 easily flows into the depressions 22b of first uneven portion 22, and the adhesion area in which adhesion portion 40 and substrate 20 are in contact with each other can be more reliably increased. On the other hand, when the arithmetic mean roughness Ra of first uneven portion 22 is 0.7 μm or less, it is possible to prevent the optical axis of second lens module 30 from being deviated when second lens module 30 is disposed on main surface 21 of substrate 20. Therefore, in optical module 1, it is possible to reliably fix second lens module 30 to substrate 20 while suppressing deviation of the optical axis or the like.

In, in optical module 1, bottom surface 31 of second lens module 30 is provided with second uneven portion 36 at least a part of a portion where bottom surface 31 is in contact with adhesion portion 40. Accordingly, adhesion portion 40 flows into the depressions 36b of second uneven portion 36, and an adhesion area where adhesion portion 40 and second lens module 30 are in contact with each other can be increased. Therefore, in optical module 1, second lens module 30 can be more reliably fixed to substrate 20.

A method of manufacturing optical module 1 according to the embodiment of the present disclosure includes preparing substrate 20 having main surface 21, preparing second lens module 30 having bottom surface 31, first side surface 32, and second side surface 33, disposing second lens module 30 on main surface 21 of substrate 20 such that bottom surface 31 faces main surface 21, and fixing second lens module 30 to substrate 20 by applying a first adhesive to a plurality of portions along first side surface 32, by applying a second adhesive to a plurality of portions along second side surface 33, and by curing the first adhesive and the second adhesive. Thus, the contact area between the adhesive and second lens module 30 and the contact area between the adhesive and substrate 20 can be increased. In addition, since the number of portions to which the adhesive is applied is increased, stress acting on second lens module 30 when the adhesive is cured, is dispersed. Therefore, deformation of second lens module 30 can be suppressed. As described above, according to the method of manufacturing optical module 1, it is possible to manufacture optical module 1 in which the deformation of second lens module 30 is suppressed while second lens module 30 is reliably fixed to substrate 20.

In the method of manufacturing optical module 1 according to an embodiment of the present disclosure, in the fixing, the first adhesive may be applied between main surface 21 and at least one of a portion of first side surface 32 close to bottom surface 31 and a portion of bottom surface 31 close to first side surface 32, the second adhesive may be applied between main surface 21 and at least one of a portion of second side surface 33 close to bottom surface 31 and a portion of bottom surface 31 close to second side surface 33, and the first adhesive and the second adhesive may be applied to be line-symmetric with respect to center line L of second lens module 30. In this method, second lens module 30 is more stably fixed to substrate 20 by the first adhesive and the second adhesive. According to the method of manufacturing optical module 1, second lens module 30 can be more reliably fixed to substrate 20.

Although the embodiments of the present disclosure have been described in detail above, the present invention is not limited to the above-described embodiments and can be applied to various embodiments. Although the first modification and the second modification have been described with reference to FIGS. 6 and 7, but a part of these modifications may be applied to the embodiment, or both the first modification and the second modification may be applied to the embodiment. In the above-described embodiment, two adhesion portions are provided along one side surface, but the present invention is not limited thereto. That is, three or more adhesion portions (e.g., first adhesion portion 41) may be provided along one side surface (e.g., first side surface 32).

What is claimed is:

1. An optical module comprising:
a substrate including a main surface;
an optical component including a bottom surface, and a first side surface and a second side surface each extending in a direction intersecting the bottom surface and facing each other, the optical component being mounted on the substrate such that the bottom surface faces the main surface; and
an adhesion portion fixing the optical component to the substrate,
wherein the adhesion portion includes a plurality of first adhesion portions provided along the first side surface and a plurality of second adhesion portions provided along the second side surface.

2. The optical module according to claim 1,
wherein the plurality of first adhesion portions and the plurality of second adhesion portions are disposed to be line-symmetric with respect to a center line, the center line passing through a center of the optical component in a direction in which the first side surface and the second side surface face each other and extending in a direction parallel to an optical axis of the optical component.

3. The optical module according to claim 1,
wherein the plurality of first adhesion portions are provided between the main surface and at least one of a portion of the first side surface close to the bottom surface and a portion of the bottom surface close to the first side surface, and
wherein the plurality of second adhesion portions are provided between the main surface and at least one of a portion of the second side surface close to the bottom surface and a portion of the bottom surface close to the second side surface.

4. The optical module according to claim 1,
wherein the plurality of first adhesion portions are provided between the main surface and a portion of the first side surface close to the bottom surface and between the main surface and a portion of the bottom surface close to the first side surface, and
wherein the plurality of second adhesion portions are provided between the main surface and a portion of the second side surface close to the bottom surface and between the main surface and a portion of the bottom surface close to the second side surface.

5. The optical module according to claim 1,
wherein the main surface of the substrate is provided with a first uneven portion in at least a part of a portion where the main surface is in contact with the adhesion portion.

6. The optical module according to claim 5,
wherein an arithmetical mean roughness Ra of the first uneven portion is equal to or greater than 0.4 μm and equal to or less than 0.7 μm.

7. The optical module according to claim 1,
wherein the bottom surface of the optical component is provided with a second uneven portion in at least a part of a portion where the bottom surface is in contact with the adhesion portion.

8. The optical module according to claim 7,
wherein the second uneven portion includes protrusions each having a rectangular cross section, a corrugated shape, or a trapezoid cross section.

9. The optical module according to claim 5,
wherein the bottom surface of the optical component is provided with a second uneven portion in at least a part of a portion where the bottom surface is in contact with the adhesion portion.

10. The optical module according to claim 1,
wherein the first side surface and the second side surface of the optical component each are provided with a third uneven portion in at least a part of a portion where the first side surface or the second side surface is in contact with the adhesion portion.

11. The optical module according to claim 1,
wherein the first side surface and the second side surface are inclined such that a distance between the first side surface and the second side surface decreases away from the bottom surface, and
wherein the adhesion portion is provided on the inclined first side surface and the inclined second side surface.

12. The optical module according to claim 1,
wherein the adhesion portion further includes at least one third adhesion portion provided along a front side surface or a rear side surface of the optical component, each of the front side surface and the rear side surface extending in a direction in which the first side surface and the second side surface each other.

13. A method of manufacturing an optical module, the method comprising:
preparing a substrate including a main surface;
preparing an optical component including a bottom surface, and a first side surface and a second side surface each extending in a direction intersecting the bottom surface and facing each other;
disposing the optical component on the main surface of the substrate such that the bottom surface faces the main surface; and
fixing the optical component to the substrate by applying a first adhesive to a plurality of portions along the first side surface, by applying a second adhesive to a plurality of portions along the second side surface, and by curing the first adhesive and the second adhesive.

14. The method of manufacturing an optical module according to claim 13,
wherein, in the fixing, the first adhesive is applied between the main surface and at least one of a portion of the first side surface close to the bottom surface and a portion of the bottom surface close to the first side surface, the second adhesive is applied between the main surface and at least one of a portion of the second side surface close to the bottom surface and a portion of the bottom surface close to the second side surface, and the first adhesive and the second adhesive are applied to be line-symmetric with respect to a center line, the center line passing through a center of the optical component in a direction in which the first side surface and the second side surface face each other and extending in a direction parallel to an optical axis of the optical component.
